(19) United States
(12) Patent Application Publication
(10) Pub. No.: US 2026/0252707 A1
(43) Pub. Date: Aug. 27, 2026

(54) AUTOMATIC SYSTEM PROMPT HARDENING FOR GENRATIVE ARTIFICIAL INTELLIGENCE SYSTEMS

(71) Applicant: Microsoft Technology Licensing, LLC, Redmond, WA (US)

(72) Inventors: Asaf HARARI, Modiin (IL); Idan HEN, Tel Aviv (IL); Ariel BRUKMAN, Kiriat Ata (IL); Ron KELLER, Ramat Hasharon (IL)

(21) Appl. No.: 19/064,472

(22) Filed: Feb. 26, 2025

(51) Int. Cl. G06F 21/57

(52) U.S. Cl. CPC G06F 21/577; G06F 2221/033

(57) ABSTRACT

Techniques are disclosed for automatically generating and/or updating system prompts for applications that interface with generative artificial intelligence (AI) models. In an aspect, data associated with an application for facilitating interactions with a generative AI model is received. A security vulnerability is identified based on the data. A system prompt is generated. The system prompt has instructions specifying how the generative AI model is to respond to a user prompt. The instructions include a rule for mitigating the identified security vulnerability. The system prompt is provided to the application, causing the application to provide the system prompt to the generative AI model such that the generative AI model responds to user prompts in accordance with the rule. In a further example, the data corresponds to a communication session between the application and the generative AI model. In another aspect, the rule is determined utilizing the generative AI model.

### BACKGROUND

Generative artificial intelligence (AI) models are utilized to generate output based on provided input. Applications can be developed in order to assist users in utilizing a generative AI model in performing various tasks. The application facilitates communication sessions between a user-facing service and the generative AI model. These applications can pose a security risk wherein a malicious entity can manipulate or otherwise utilize the application and the generative AI model to access sensitive data. For instance, a user can manipulate an application to perform operations it is not intended to allow in order to expose sensitive data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein are related to security with respect to generative artificial intelligence (AI) systems. For example, techniques described herein provide improved security and/or performance with respect to applications that facilitate interactions with generative AI models. In an aspect, a system prompt manager receives data associated with an application for facilitating interactions with a generative AI model. The system prompt manager identifies a security vulnerability of the application based at least on the data. The system prompt manager generates a system prompt comprising instructions specifying how the generative AI model is to respond to user prompts. The instructions comprise a rule for mitigating the security vulnerability. The system prompt manager causes the application to provide the system prompt to the generative AI model, causing the generative AI model to respond to a user prompt in accordance with the rule.

In a further example, the system prompt manager selects a prompt template from among a plurality of prompt templates based on the application type, the identified vulnerability, and/or other data. The system prompt manager utilizes the selected prompt template in generating the system prompt.

In a further example, the system prompt manager utilizes the generative AI model in order to generate a rule for mitigating the security vulnerability.

In a further example, the system prompt manager identifies another vulnerability and updates the system prompt with an additional rule to mitigate the another vulnerability.

In a further example, the system prompt manager generates or updates the system prompt responsive to detecting an attack with respect to the application.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for automatic system prompt hardening in generative artificial intelligence systems, in accordance with an example embodiment.

FIG. 2 shows a block diagram of a system for automatic system prompt hardening in generative artificial intelligence systems, in accordance with another example embodiment.

FIG. 3 shows a flowchart of a process for hardening a system prompt, in accordance with an example embodiment.

FIG. 4 shows a flowchart of a process for causing an application to utilize a system prompt, in accordance with an example embodiment.

FIG. 5 shows a flowchart of a process for causing an application to utilize a system prompt, in accordance with another example embodiment.

FIG. 6 shows a flowchart of a process for obtaining data associated with an application, in accordance with an example embodiment.

FIG. 7 shows a flowchart of a process for identifying a security vulnerability with respect to an application, in accordance with an example embodiment.

FIG. 8 shows a flowchart of a process for hardening an existing system prompt, in accordance with an example embodiment.

FIG. 9 shows a flowchart of a process for determining a rule, in accordance with an example embodiment.

FIG. 10 shows a flowchart of a process for generating a system prompt based on a template, in accordance with an example embodiment.

FIG. 11 shows a flowchart of a process for further hardening a system prompt, in accordance with an example embodiment.

FIG. 12 shows a system for application-side system prompt hardening, in accordance with an example embodiment.

FIG. 13 shows a flowchart of a process for application-side system prompt hardening, in accordance with an example embodiment.

FIG. 14 shows a block diagram of an example computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for System Prompt Hardening

Generative artificial intelligence (AI) models are generated based on training data, such that the underlaying patterns and structures of their training data are incorporated into the algorithm of the model. The generative AI model can then be used to generate output data/content based on input prompts. The content generated by a generative AI model can be complex, coherent, and/or original. For instance, a generative AI model can generate sophisticated sentences, lists, ranges, tables of data, images, essays, and/or the like, depending on the particular model and its training data. An example of a generative AI model is a language model. A language model is a model that estimates the probability of a token or sequence of tokens occurring in a longer sequence of tokens. In this context, a “token” is an atomic unit on which the model is trained and on which the model makes predictions. For instance, a token can be a word, a character (such as an alphanumeric character, a blank space, a symbol, etc.), or a sub-word (such as a root word, a prefix, or a suffix). In other types of models (such as image based models) a token represents another kind of atomic unit (such as a subset of an image).

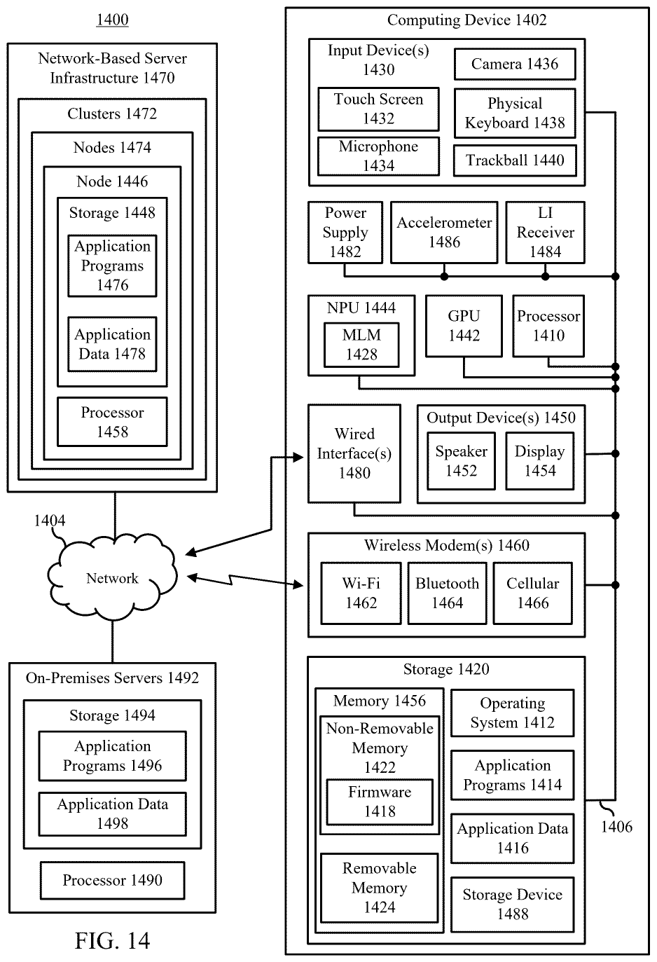

A large language model (LLM) is a language model that has a high number of model parameters, such as millions, billions, trillions, or even greater numbers of parameters. Model parameters of an LLM are the weights and biases generated for the model during training. An LLM is (pre-)trained using self-supervised learning and/or semi-supervised learning. For instance, an LLM may be trained by exposing the LLM to (e.g., large amounts of) text, such as predetermined datasets, books, articles, text-based conversations, webpages, transcriptions, forum entries, and/or any other form of text and/or combinations thereof. Training data may be provided from various sources, such as a database, the Internet, specific systems, and/or the like. Additional details regarding generative AI models such as LLMs are described with respect to FIG. 14, as well as elsewhere herein.

Developers can design applications that interface with generative AI models on behalf of users in order to facilitate using the generative AI model to perform a function or provide data related to a topic or subset of topics. For instance, a developer can design an application for assisting customers in booking flights that utilizes the generative AI model to determine information about the flight, potential flight routes, cost or time saving opportunities, potential flight dates, and/or the like. These applications can pose security risks where a user provides sensitive information that is then provided to the generative AI model, potentially exposing the sensitive information to third parties. Furthermore, a malicious actor (for example, a hacker) can manipulate a generative AI model in attacks such as jailbreak attacks or denial-of-wallet attacks. Traditional cybersecurity measures, such as firewalls, encryption, and authentication, can be insufficient or difficult to implement in securing applications that interface with generative AI models. Instead, hardening of input or output of the generative AI model is used to improve security.

Existing techniques for hardening applications and generative AI models rely on general-purpose methods. For instance, adversarial examples or noise injection can be used to test the robustness of generative AI models. These techniques, however, can fail to consider semantic and pragmatic aspects of natural language generation. Other methods employ heuristics or rules that filter out harmful or inappropriate responses, but fail to account for diversity and complexity in natural language expression. Moreover, these existing methods focus on hardening user prompts and model responses.

Embodiments of the present disclosure direct cybersecurity measures to the hardening of system prompts. A system prompt is an input that an application provides to the generative AI model comprising instructions regarding a task the generative AI model is to perform for the application. Instructions can specify domain information, desired output, or other rules and/or guidelines the generative AI model is to follow when performing the task. The system prompt can affect the generative AI model's output in terms of content, style, tone, relevance, and coherence. Embodiments are disclosed herein for a system prompt manager that identifies security vulnerabilities of an application, generates a system prompt for mitigating the identified security vulnerabilities, and deploys the system prompt to the application. The generated system prompt can specify instructions or guidelines for responding to user prompts such as instructions for detecting forbidden user requests, preventing forbidden actions, preventing forbidden responses, redirecting a forbidden request, denying a forbidden request, and/or otherwise improving the quality or security of responses and/or actions of the application utilizing a generative AI model. Such implementations avoid malicious or undesired generative AI model behavior. Furthermore, a system prompt is not usually accessible to users interacting with the application. In this context, the hardened system prompt provides an immune mechanism against attacks that would otherwise leverage the identified security vulnerability. Thus, a system prompt generator improves security with respect to generative AI models by preventing cyberattacks such as jailbreak attacks and denial-of-wallet attacks.

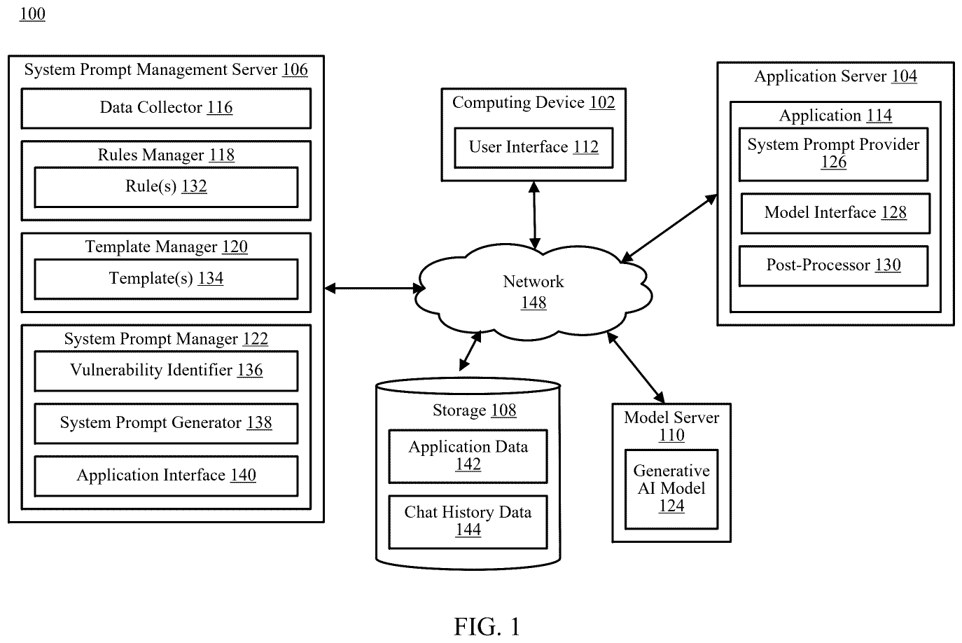

Embodiments described herein can be configured in various ways or hardening a system prompt. For instance, FIG. 1 shows a block diagram of a system 100 for automatic system prompt hardening in generative artificial intelligence systems, in accordance with an example embodiment. As shown in FIG. 1, system 100 comprises a computing device 102, an application server 104, a system prompt management server 106, a storage 108, and a model server 110. In an embodiment, and as shown in FIG. 1, computing device 102, application server 104, system prompt manager server 106, storage 108, and model server 110 are communicatively coupled by a network 148. In examples, network 148 comprises one or more networks such as local area networks (LANs), wide area networks (WANs), enterprise networks, the Internet, etc. In examples, network 148 comprises one or more wired and/or wireless portions. The features of system 100 are described in detail as follows.

Storage 108 stores data used by, generated by, and/or obtained from computing device 102, application server 104, system prompt manager server 106, and/or model server 110, and/or components thereof and/or services executing thereon. For instance, as shown in FIG. 1, storage 108 stores application data 142 and chat history data 144. In embodiments, application data 142 specifies information regarding one or more applications executed by application servers (such as application server 104). Examples of application data include, but are not limited to, application identifiers that uniquely identify a respective application, application usage logs, application type data that specifies a type of a respective application, application access policies that specify accounts or resources that are authorized to access an application and/or data/resources the application is authorized to access, and/or other information related to one or more applications. In embodiments, chat history data 144 comprises historical data of one or more communication sessions between applications and/or user accounts and a generative AI model hosted by a model server (such as model server 110). Chat history data 144 can be a log of an ongoing communication session (also referred to as an “active session” or a “live session”) or a log of a previous communication session that has ended (also referred to as a “past session”). In an embodiment, chat history data 144 is set to expire after a predetermined period of time or after the corresponding communication session has ended. As shown in FIG. 1, storage 108 is external to computing device 102, application server 104, system prompt management server 106, and model server 110. Alternatively, all or a portion of storage 108 is internal to computing device 102, application server 104, system prompt management server 106, and/or model server 110. An implementation of storage 108 is a remote storage accessible over a network (such as network 148).

In examples, computing device 102 is any type of stationary or mobile processing device, including, but not limited to, a desktop computer, a server, a mobile or handheld device (such as a tablet, a personal data assistant (PDA), a smart phone, a laptop, etc.), an Internet-of-Things (IOT) device, etc. In accordance with an embodiment, computing device 102 is associated with a user (such as an individual user, a group of users, an organization, a family user, a customer user, an employee user, an admin user (such as a service team user, a developer user, a management user, etc.), etc.). Computing device 102 is configured to execute a user interface 112 (“UI 112” herein). UI 112 is any type of user interface for displaying information and/or receiving input from a user interacting with computing device 102. Examples of UI 112 include, but are not limited to, graphic user interfaces (GUIs), command-line interfaces, voice user interfaces, menu driven interfaces, form based interfaces, natural language interfaces, and/or any other type of interface suitable for handling interaction between a user and computing device 102. In accordance with an embodiment, UI 112 enables a user to interface with application server 104, system prompt management server 106, storage 108, and/or model server 110. In an embodiment, UI 112 is a user-facing interface of an application for interacting with a generative AI model. In an embodiment, UI 112 utilizes one or more application programming interface (API) of an application or generative AI model in submitting queries or establishing communication sessions.

Application server 104, system prompt management server 106, and model server 110 are network-accessible servers or other type of computing devices. In accordance with an embodiment, one or more of application server 104, system prompt management server 106, and model server 110 are incorporated in a network-accessible server set (such as a cloud-based environment, an enterprise network server set, and/or the like). In an embodiment, and as shown in FIG. 1, each of application server 104, system prompt management server 106, and model server 110 are a single server or other computing device. In an alternative example embodiment, application server 104, system prompt management server 106, and model server 110 are implemented across multiple servers or computing devices (such as in a distributed server implementation) or integrated in as a single server. Each of application server 104, system prompt management server 106, and model server 110 are configured to execute services and/or store data. For instance, as shown in FIG. 1, application server 104 hosts an application 114, system prompt manager server 106 hosts a data collector 116, a rules manager 118, a template manager 120, and a system prompt manager 122, and a model server 110 hosts a generative AI model 124. In an embodiment, UI 112 interfaces with application 114, data collector 116, rules manager 118, template manager 120, system prompt manager 122, and/or model server 110 over network 148.

Application 114 is an application configured to facilitate interactions between a user or user-facing application and a generative AI model. For instance, in an embodiment, application 114 facilitates interactions between UI 112 and generative AI model 124. Application 114 can manage communication sessions between UI 112 and generative AI model 124 (also referred to herein as “chat sessions”), receive user queries, respond to user queries, interact with generative AI model 124 to answer user queries, perform other operations related to facilitating communication between a user or user-facing application and generative AI model, and/or performing operations regarding the application's intended use. Examples of application 114 include, but are not limited to, an application for guiding customers through performing an operation (such as a flight-booking application that guides customers through booking or selecting a flight), an application for determining a product to purchase, an application for converting natural language queries to query language queries, an application for researching information related to topic(s), and/or any other type of application that can leverage a generative AI model in performing tasks on behalf of and/or at the instruction of a user or user-facing service. As shown in FIG. 1, application 114 comprises a system prompt provider 126, a model interface 128, and a post-processor 130, each of which are further described herein.

System prompt provider 126 comprises logic for providing a system prompt to generative AI model 124. In accordance with an embodiment, system prompt provider 126 facilitates establishing a communication session between UI 112 and generative AI model 124. Depending on the implementation, system prompt provider 126 can establish the communication session prior to or as part of providing a system prompt to generative AI model 124. In some implementations, application 114 does not initially include system prompt provider 126. For instance, instead of system prompt provider 126, an implementation of application 114 can use a session manager that establishes and manages communication sessions without providing a system prompt to generative AI model 124. In this context, system prompt manager 122 deploys logic to application 114 for implementing system prompt provider 126. In some implementations, the logic for establishing and managing communication sessions is separate from the logic for providing a system prompt.

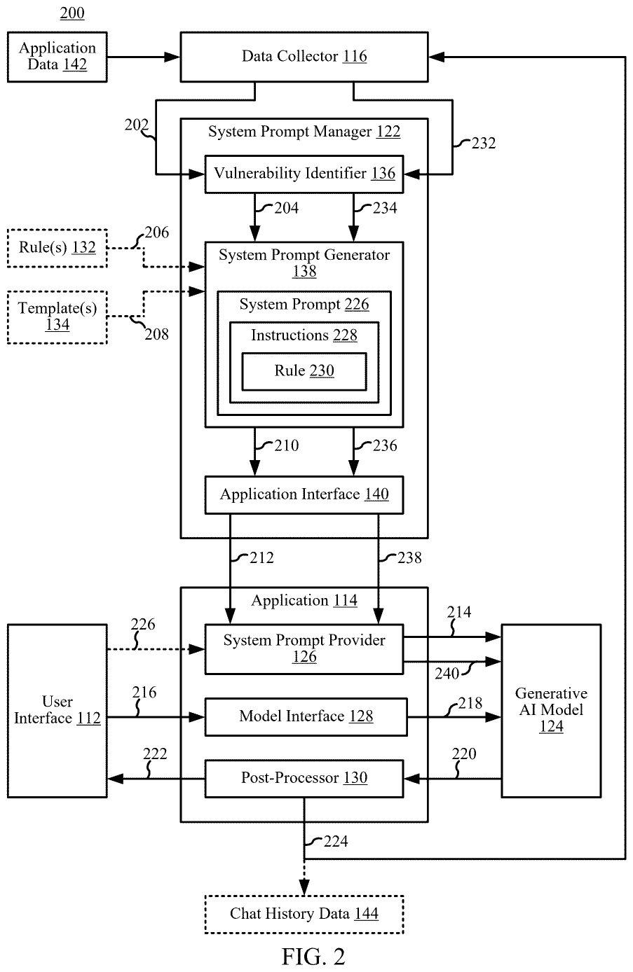

Model interface 128 comprises logic for receiving queries from UIs such as UI 112, providing a prompt to generative AI model 124 to cause the generative AI model 124 to generate a response to a query, and/or perform other operations with respect to interfacing with a generative AI model. In accordance with an embodiment, model interface 128 provides the prompt to generative AI model 124 as an API call of generative AI model 124. In accordance with an embodiment, model interface 124 includes an interface for communicating with generative AI model 124 via network 148. Additional details regarding model interface 124 are described with respect to FIGS. 2-5, 12, and 13, as well as elsewhere herein.

Post-processor 130 comprises logic for parsing output received from generative AI model 124, validating output received from generative AI model 124, providing/storing communication session data, providing processed output to UI 112, and/or performing other operations with respect to post-processing output received from generative AI model 124. In accordance with an embodiment, post-processor 130 comprises respective interfaces for communicating with UI 112, data collector 116, and/or generative AI model 124 via network 148. Additional details regarding post-processor 130 are described with respect to FIG. 2, as well as elsewhere herein.

Data collector 116 is a computer-implemented service, component, or combination of services and components. Data collector 116 collects data related to generative AI models, applications that interface with the generative AI models, chat sessions with generative AI models, best practices for providing prompts to generative AI applications, cyber attacks related to applications or generative AI applications, and/or other data related to operation of system 100. Examples of data related to chat sessions include, but are not limited to, user prompts, system prompts, generative AI model generated responses to prompts, and/or the like. Data collector 116 in an implementation collects data from a single application, with respect to a single user account, or with respect to a single generative AI model. Alternatively, data collector 116 collects data from across multiple applications, user accounts, and/or generative AI models. For instance, in a non-limiting example, data collector 116 collects data with respect to an application across multiple user accounts. In this example, data can be analyzed and system prompts can be tailor-generated for hardening with respect to uses of that application. In some implementations, data collector 116 collects user-generated or expert-generated feedback regarding the quality of responses generated by the application and generative AI model or the performance of the application or generative AI model. Data collected by data collector 116 can be in various formats including, but not limited to, a tabular format, a text file format, a document file format, an image format, a video format, a vector format, and/or other data formats suitable for exporting, collecting, measuring, and/or storing data. In an embodiment, data collector 116 stores collected data in a centralized data store (such as storage 108).

Rules manager 118 is a computer-implemented service, component, or combination of services and components. Rules manager 118 manages one or more rules 132 (“rules 132” herein). Rules 132 specify operations or techniques for mitigating security vulnerabilities. A rule of rules 132 can specify a type of question the generative AI model is to answer, specify a type of response the generative AI model is to provide, specify certain information the generative AI model is to reject, specify types of data the generative AI model is allowed to provide or not allowed to provide, specify types of data the generative AI model is not allowed to receive or analyze, specify a response the generative AI model is to provide with respect to a certain request or subset of requests, specify a question the generative AI model is to present (for instance, at the start of a communication session), specify a tone the generative AI model is to respond with, and/or other operations or techniques for mitigating security vulnerabilities. For example, a rule can specify sensitive data a generative AI model is to avoid providing and a service, portal, or web page the generative AI model is to recommend or redirect to in response to requests for the sensitive data. Rules of rules 132 can be pre-generated or predetermined manually by a developer of system prompt manager 122 or rules manager 118. Alternatively, one or more rules of rules 132 are generated automatically. For example, rules manager 118 or system prompt manager 122 (or a subcomponent thereof) can automatically generate a rule for mitigating a security vulnerability. A security vulnerability is a weakness in a system that can be exploited (such as by a hacker) to negatively impact confidentiality, integrity, or availability of the system. Security vulnerabilities can be flaws or errors in the system, in hardware components of the system, in software executed by the system, in a network the system is communicatively coupled to, in an internal network of the system, and/or the like. The security vulnerability can be a general security vulnerability, an application-specific vulnerability, or a model-specific vulnerability. In an implementation, rules manager 118 (or system prompt manager 122, as described elsewhere herein) provides a prompt to generative AI model 124 (or another generative AI model) that causes the generative AI model to generate a rule for a specified security vulnerability. As a non-limiting example, suppose rules manager 118 provides a prompt to generative AI model 124 for generating a rule for preventing release of credit card information. In this context, the prompt causes generative AI model 124 to generate a rule specifying queries for credit card information are to be denied. In some embodiments, system prompt manager 122 (or a component thereof) provides rules to be stored/managed by rules manager 118.

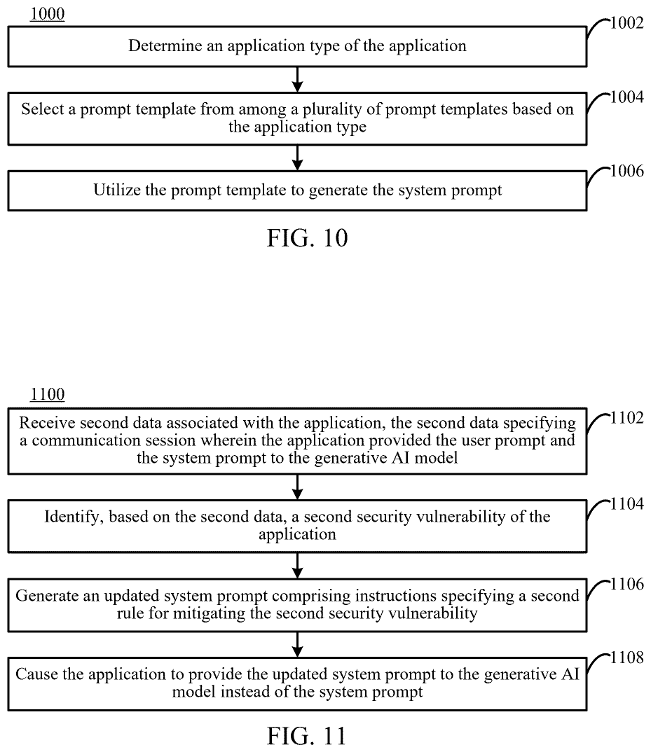

Template manager 120 is a computer-implemented service, component, or combination of services and components. Template manager 120 manages one or more templates 134 (“templates 134” herein). Templates 134 are predefined structures of system prompts or parts thereof. A template can specify the structure, content, or tone of a system prompt. In some embodiments, a template comprises a rule of rules 132. Templates 134 can be tailored with respect to types of applications (for example, with respect to a domain of an application), scenarios of interactions (for example, with respect to a scenario an application can be used for), types of generative AI models, with respect to certain types of vulnerabilities or attacks, and/or the like. A template can be tagged with a template identifier that enables a system or service to retrieve or otherwise obtain the template from template manager 120. Template identifiers can specify an application, scenario, application type, generative AI model type, vulnerability type, attack type, and/or another situation or service the template is to be used with respect to. For instance, in an example, suppose a template of templates 134 is tagged with a payment information scenario identifier. In this example, the template can include an instruction that states “Do not respond to a request related to credit cards. Instead, refer the customer to [payment system].” In this example, the template can be completed by inserting a name or address of the payment system a user is to use instead of the generative AI model. Additional details regarding templates are described with respect to FIG. 10, as well as elsewhere herein.

System prompt manager 122 is a computer-implemented service, component, or combination of services and components. System prompt manager 122 manages system prompts on behalf of applications that interface with generative AI models such as generative AI model 124. As shown in FIG. 1, system prompt manager 122 comprises a vulnerability identifier 136, a system prompt generator 138, and an application interface 140. Vulnerability identifier 136 comprises logic for identifying vulnerabilities based on data collected with respect to an application and/or generative model. For instance, vulnerability identifier 136 identifies security vulnerabilities based on data collected by data collector 116. In an embodiment, vulnerability identifier 136 utilizes best practices or known risks in order to evaluate data collected by data collector 116 to identify a potential security vulnerability. If the application or generative AI model is out of alignment with best practices or operates in a similar manner as known risks, vulnerability identifier 136 identifies a security vulnerability. In another implementation, vulnerability identifier 136 comprises risk assessment logic to determine a level of risk an application is at with respect to the vulnerability. If the level of risk satisfies a threshold condition, vulnerability identifier 136 identifies a security vulnerability. Vulnerability identifier 136 can specify the security vulnerability at a variety of granularities. For instance, vulnerability identifier 136 in an implementation can identify a security vulnerability in an application's overall operation, with respect to certain scenarios, with respect to a specific operation, with respect to a specific phrase within a prompt, or at other degrees of granularity.

System prompt generator 138 comprises logic for generating system prompts comprising rules for mitigating security vulnerabilities. In embodiments, system prompt generator 138 selects or determines rules based on vulnerabilities identified by vulnerability identifier 136. System prompt generator 138 can generate rules automatically or select pre-existing rules (such as, rules 132) to include in the system prompt. For instance, in an embodiment, system prompt generator 138 accesses rules 132 of rules manager 118 and determines which rules to include in a system prompt to mitigate an identified vulnerability. In another implementation, system prompt generator 138 accesses a template of templates 134 of template manager 120 that is tagged with an identifier related to the identified vulnerability, an identifier related to the application, an identifier related to the generative AI model, and/or another identifier relevant to the application or scenario the system prompt is to be generated for. In another implementation, system prompt manager 122 leverages a generative AI model, such as generative AI model 124, to automatically generate a rule based on an identified security vulnerability. For instance, in an example, system prompt manager 122 provides a prompt to generative AI model 124 requesting generative AI model 124 to generate a rule for mitigating the identified security vulnerability. In this example, system prompt manager 122 receives the rule and evaluates whether or not the rule is valid for mitigating the identified security vulnerability. By automatically generating rules in this manner, system prompt generator 138 is able to adapt system prompts to newly identified security vulnerabilities that do not have a corresponding pre-existing rule, thereby improving security of applications that interface with generative AI models. In some embodiments, system prompt generator 138 modifies or otherwise updates existing system prompts. Alternatively, system prompt generator 138 rewrites over an existing system prompt.

Application interface 140 comprises logic for monitoring applications and deploying system prompts to applications. For instance, in an implementation, application interface 140 receives a system prompt generated by system prompt generator 138 and distributes the prompt to application 114 (and other instances of the application, if any). In some implementations, application interface 140 also comprises logic for determining when or if system prompts are to be updated. For example, a further implementation of application interface 140 determines if a system prompt is “stale” or has not been updated for at least a predetermined amount of time. In this context, application interface 140 causes system prompt manager 122 to re-evaluate whether or not a new system prompt is to be generated/updated. By causing system prompt manager 122 to determine if a stale system prompt is to be updated, application interface 140 can cause system prompt manager 122 to detect potential vulnerabilities that could be missed by external monitoring services. In another implementation, application interface 140 comprises logic for monitoring activity of application 114. If application interface 140 detects irregular or anomalous activity of application 114, it can cause system prompt manager 122 to evaluate whether or not the system prompt is to be updated to mitigate irregular or anomalous behavior.

Generative AI model 124 is configured to generate output based on input. In accordance with an embodiment, generative AI model 124 is an LLM. In an example, generative AI model 124 is trained using public information (such as information collected and/or scrubbed from the Internet) and/or data stored by an administrator of model server 110 (such as data stored in memory of model server 110 and/or memory accessible to model server 110). In accordance with an embodiment, generative AI model 124 is an “off the shelf” model trained to generate complex, coherent, and/or original content based on prompts. Alternatively, generative AI model 124 is a specialized model trained to generate a type of output based on prompts.

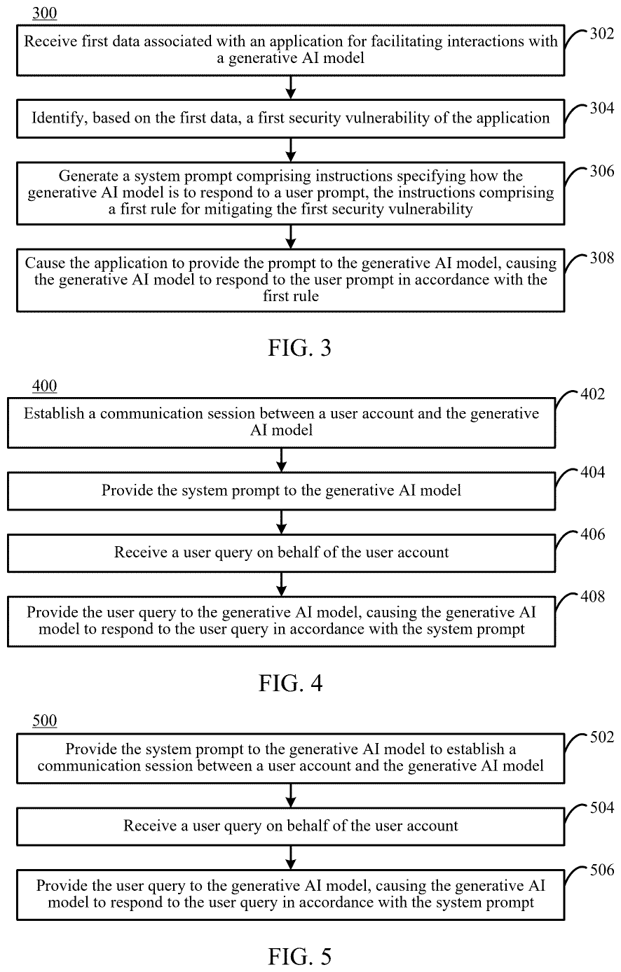

Systems described herein operate in various ways to harden system prompts. For instance, FIG. 2 shows a block diagram of a system 200 for automatic system prompt hardening in generative artificial intelligence systems, in accordance with another example embodiment. System 200 comprises user interface 112, application 114 (comprising system prompt provider 126, model interface 128, and post-processor 130), data collector 116, system prompt manager 122 (comprising vulnerability identifier 136, system prompt generator 138, and application interface 140), generative AI model 124, and application data 142, as described with respect to FIG. 1. In some embodiments, and as also shown in FIG. 2, system 200 can further include rules 132, templates 134, and/or chat history data 144. In order to better understand the operation of system prompt manager 122 with respect to FIG. 2, FIG. 2 is described with respect to FIG. 3. FIG. 3 shows a flowchart 300 of a process for hardening a system prompt, in accordance with an example embodiment. In an embodiment, system prompt manager 122 of FIG. 2 operates according to flowchart 300. Note not all steps of flowchart 300 need be performed in all embodiments. Further structural and operational embodiments will be apparent to persons skilled in the relevant art(s) based on the following descriptions of FIG. 2 and FIG. 3.

Flowchart 300 begins with step 302. In step 302, first data associated with an application for facilitating interactions with a generative AI model is received. For example, vulnerability identifier 136 of FIG. 2 receives data 202 associated with application 114. As shown in FIG. 2, vulnerability identifier 136 receives data 202 from data collector 116. Data collector 116 generates data 202 based on application data 142 and other activity of application 114. In an embodiment, vulnerability identifier 136 receives data 202 when there is new activity performed with respect to application 114. Alternatively, vulnerability identifier 136 periodically obtains data 202 from data collector 116.

In step 304, a first security vulnerability of the application is identified based on the first data. For example, vulnerability identifier 136 identifies a security vulnerability 204 based at least on data 202. In an implementation vulnerability identifier 136 identifies factors that influence output generated by generative AI model 124. Examples of vulnerabilities that vulnerability identifier 136 can identify include, but are not limited to, a risk of releasing a user's personal identifying information, a risk of exposing financial information of a user, a risk of exposing a user's login or other credentials, potential of exposing sensitive information of an organization, a user instructing the generative AI model to ignore instructions or the system prompt, and/or exposing other sensitive information or potential exploitations. In an embodiment, vulnerability identifier 136 references a list or database of known security vulnerabilities to identify vulnerabilities in application 114. The list can be maintained by system prompt manager 122 or obtained from use of a generative AI model, such as generative AI model 124. For instance, in an embodiment, vulnerability identifier 136 queries generative AI model 124 for a list of security vulnerabilities in a domain similar to the domain of application 114. In another embodiment, vulnerability identifier 136 analyzes previous cyberattack data to determine potential vulnerabilities. Vulnerability identifier 136 in an implementation compares known vulnerabilities to data 202 to determine whether or not application 114 is potentially subject to a vulnerability. In a further implementation, vulnerability identifier 136 determines a level of similarity between application 114 and systems or services that were subject to previous attacks or vulnerabilities (also referred to as “compromised systems” or “compromised services” herein). If the level of similarity satisfies a threshold, vulnerability identifier 136 determines the application 114 is at risk of the same vulnerabilities as the systems or services. As shown in FIG. 2, vulnerability identifier 136 provides security vulnerability 204 to system prompt generator 138.

In step 306, a system prompt is generated, the system prompt comprising instructions specifying how the generative AI model is to respond to a user prompt, the instructions comprising a first rule for mitigating the first security vulnerability. For example, system prompt generator 138 of FIG. 2 generates a system prompt 226. System prompt 226 comprises instructions 228 specifying how generative AI model is to respond to a user prompt. Instructions 228 comprise at least a rule 230 for mitigating security vulnerability 204. System prompt generator 138 generates system prompt 226 in various ways. For instance, system prompt generator 138 rewrites an existing prompt to generate system prompt 226, updates an existing prompt to generate system prompt 226, or writes a new system prompt to generate system prompt 226, depending on the implementation. In some situations, and as optionally shown in FIG. 2 and further described with respect to FIG. 10 (as well as elsewhere herein), system prompt generator 138 uses a template 208 of templates 134 to generate system prompt 226. In some situations, and as optionally shown in FIG. 2 and further described with respect to FIG. 8 (as well as elsewhere herein), system prompt generator 138 determines a rule 206 of rules 132 and inserts it as rule 230 of system prompt 226. In some embodiments, system prompt generator 138 modifies the system prompt using a cue, hint, or question that guides generative AI model 124 toward a desired response or to avoid undesired responses. For instance, in a scenario where vulnerability identifier 136 evaluates user feedback to identify an issue or vulnerability, system prompt generator 138 generates the system prompt to include a rule that addresses a deficiency or other issue indicated in the feedback. As shown in FIG. 2, system prompt generator 138 provides system prompt 226 to application interface 140 in a prompt signal 210.

In step 308, the application is caused to provide the prompt to the generative AI model, causing the generative AI model to respond to the user prompt in accordance with the first rule. For example, application interface 140 of FIG. 2 causes application 114 to provide system prompt 226 generative AI model 124. System prompt 226 causes generative AI model 124 to respond to user prompts in accordance with rule 230. As shown in FIG. 2, application interface 140 deploys system prompt 226 to application 114 via a prompt deployment signal 212. Prompt deployment signal 212 causes application 114 to overwrite an existing system prompt with system prompt 226. In some embodiments, application 114 does not include an existing system prompt. In this context, prompt deployment signal 212 comprises logic that causes application 114 to provide system prompt 226 prior to providing a user prompt to generative AI model 124.

In embodiments, and as further described with respect to FIGS. 4 and 5, system prompt provider 126 provides system prompt 226 to generative AI model 124 in a system prompt signal 214. System prompt 226 causes generative AI model 124 to respond to user prompts in accordance with rule 230. For instance, as shown in FIG. 1, UI 112 provides a user query 216 to model interface 128. Model interface provides a user prompt signal 218 corresponding to user query 216 requesting generative AI model 124 to generate a response to user query 216. System prompt 226 causes generative AI model 124 to generate a response 220 in accordance with rule 230. Post-processor 130 provides a query response 222 based on response 220. As also shown in FIG. 2, data collector 116 receives chat history event 224 representative of system prompt 226, user prompt 218, and response 220. In some embodiments, post-processor 130 stores chat history event 224 in storage as chat history data 144.

### III. Application and Generative AI Model Interface Embodiments

As described herein, system prompt manager 122 provides a system prompt to application 114 in order to cause application 114 to provide the system prompt to generative AI model 124. Application 114 can operate to provide a system prompt to generative AI model 124 in a variety of ways. For instance, FIG. 4 shows a flowchart 400 of a process for causing an application to utilize a system prompt, in accordance with an example embodiment. In an embodiment, application 114 of FIG. 2 operates according to flowchart 400. Note not all steps of flowchart 400 need be performed in all embodiments. Further structural and operational embodiments will be apparent to persons skilled in the relevant art(s) based on the following description of FIG. 4 with respect to FIG. 2.

Flowchart 400 begins with step 402. In step 402, a communication session is established between a user account and the generative AI model. For example, system prompt provider 126 establishes a communication session between UI 112 (or on behalf of a user account associated therewith) and generative AI model 124. In an implementation, system prompt provider 126 establishes the communication session subsequent to a session request 226 received from UI 112. UI 112 can provide session request 226 subsequent to computing device 102 launching a user-facing application corresponding to application 114 (for example, a front-end application component of application 114), subsequent to computing device 102 navigating to a web page that corresponds to application 114, subsequent to user interaction with a widget displayed in UI 112 that corresponds to initiating communication with application 114, interaction with a component of a front-end application component of application 114 that corresponds to an operation to establish a communication session with generative AI model 124, interaction with a component that corresponds to an operation that utilizes generative AI model 124, and/or the like. In some embodiments, the communication session has an expiration time wherein a lack of further interaction or messages received from UI 112 within a predetermined length of time causes application 114 to end the communication session. Alternatively or additionally, the communication session ends automatically when a front-end component of application 114 is closed on computing device 102.

Flowchart 400 continues with steps 404-408. In an embodiment, steps 404-408 are caused by application interface 140 (or another component of system prompt manager 122) performing step 308 of flowchart 300, as described with respect to FIG. 3. In step 404, the system prompt is provided to the generative AI model. For example, system prompt provider 126 provides system prompt 226 to generative AI model 124 via a system prompt signal 214. As described elsewhere herein, system prompt 226 causes generative AI model to respond to user prompts in accordance with rules of the prompt.

In step 406, a user query is received on behalf of the user account. For example, model interface 128 of FIG. 2 receives a user query 216. Model interface 128 processes user query 216 to generate a user prompt 218. Depending on the implementation, user prompt 218 comprises user query 216 or is otherwise generated in accordance with answering, fulfilling, or otherwise responding to user query 216.

In step 408, a user prompt comprising the user query is provided to the generative AI model, causing the generative AI model to respond to the user prompt in accordance with the system prompt. For example, model interface 128 provides user prompt 218 to generative 124, causing generative AI model to respond to user prompt 218 in accordance with system prompt 226. As described with respect to step 406, in an implementation, user prompt 218 comprises user query 216. As shown in FIG. 2, generative AI model 124 generates a response 220 in accordance with rules and other instructions of system prompt 226. For example, suppose rule 230 specified generative AI model 124 is to ignore requests for payment info and instead redirect the requesting service or user to a payment service and user query 216 is a query for payment info of a user account. In this example, user prompt 218 and system prompt 226 cause generative AI model 124 to generate response 220 redirecting UI 112 to a payment service without exposing payment info of the user account. Post-processor 130 receives response 220 and processes it into query response 222. Post-processor 130 provides query response 222 to UI 112 for display thereof and/or further processing.

As described herein, application 114 can operate to provide a system prompt to generative AI model 124 in a variety of ways. For instance, in another embodiment, application 114 provides a system prompt to establish a communication session with generative AI model 124, such as the operations described with respect to FIG. 5. FIG. 5 shows a flowchart 500 of a process for causing an application to utilize a system prompt, in accordance with another example embodiment. In an embodiment, application 114 of FIG. 2 operates according to flowchart 500. Note not all steps of flowchart 500 need be performed in all embodiments. In an embodiment, one or more steps of flowchart 500 are caused by application interface 140 (or another component of system prompt manager 122) performing step 308 of flowchart 300, as described with respect to FIG. 3 Further structural and operational embodiments will be apparent to persons skilled in the relevant art(s) based on the following description of FIG. 5 with respect to FIG. 2.

Flowchart 500 begins with step 502. In step 502, the system prompt is provided to the generative AI model to establish a communication session between a user account and the generative AI model. For example, system prompt provider 126 of FIG. 2 provides system prompt 226 to generative AI model 124 as system prompt signal 214 to establish a communication session between UI 112 (or on behalf of a user account associated therewith) and generative AI model 124. In some cases, system prompt provider 126 provides system prompt signal 214 responsive to receiving session request 226, such as in a similar manner as described with respect to step 402 of flowchart 400 of FIG. 4. In an embodiment, system prompt signal 214 also includes a communication session request and or credentials for initiating the communication session.

In step 504, a user query is received on behalf of the user account. For example, model interface 128 receives user query 216 from UI 112, such as in a similar manner as described with respect to step 406 of flowchart 400 of FIG. 4.

In step 506, a user prompt comprising the user query is provided to the generative AI model, causing the generative AI model to respond to the user prompt in accordance with the system prompt. For example, model interface 128 provides user prompt 218 comprising user query 216 is provided to generative AI model 124, causing generative AI model to generate a response 220 in accordance with system prompt 226, such as in a similar manner as described with respect to step 408 of flowchart 400 of FIG. 4.

### IV. Reactive System Prompt Hardening Embodiments

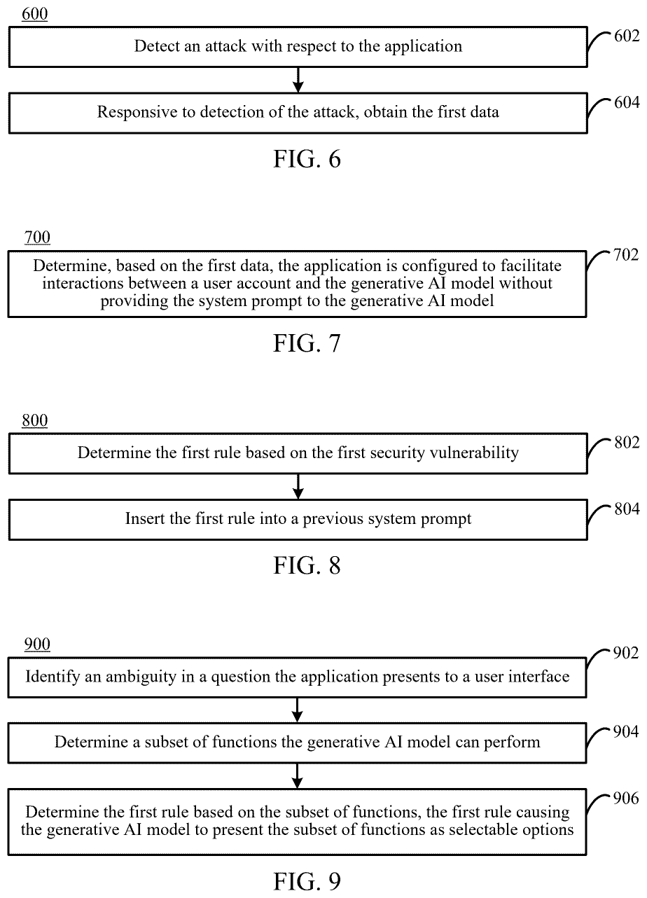

Embodiments of the present disclosure harden system prompts in order to mitigate security vulnerabilities in applications that interface with generative AI models. System prompt hardening can be proactive, reactive, or a combination of both. In reactive system prompt hardening, a system prompt manager automatically implements mitigation techniques in response to a cyberattack. Depending on the implementation, the cyberattack can be with respect to the application the system prompt is generated for, a type of the application, a provider associated with the application, a device the application is deployed to, a cloud computing environment the application is deployed to, and/or the like. System prompt managers such as system prompt manager 122 of FIG. 2 operate in various ways to perform system prompt hardening in response to detected attacks. For instance, FIG. 6 shows a flowchart 600 of a process for obtain data associated with an application, in accordance with an example embodiment. In an embodiment, data collector 116 of FIG. 2 operates according to flowchart 600. In an embodiment, one or more steps of flowchart 600 are further embodiments of step 302 of flowchart 300 of FIG. 3. Note not all steps of flowchart 600 need be performed in all embodiments. Further structural and operational embodiments will be apparent to persons skilled in the relevant art(s) based on the following description of FIG. 6 with respect to FIG. 2.

Flowchart 600 begins with step 602. In step 602, an attack with respect to the application is detected. For example, vulnerability identifier 136 of FIG. 2 detects an attack with respect to application 114. In an embodiment, vulnerability identifier 136 detects the attack based on data associated with application 114. Alternatively, vulnerability identifier 136 receives an indication of an attack from an external attack detection service. For instance, suppose an external attack detection service (not shown in FIG. 2 for brevity) detects an attack against application 114 or applications similar to application 114. Examples of applications similar to application 114 include, but are not limited to, applications within the same domain as application 114, applications from the same application provider as application 114, applications that perform functions with a level of similarity to functions of application 114 that satisfies a similarity criterion, applications with access to the same resources as application 114, applications with access to the same types of resources as application 114, and/or the like. In this context, the external attack detection service can transmit an alert to vulnerability identifier 136 indicative of the attack. Alternatively, vulnerability identifier 136 can query the external attack detection service for potential attacks. For instance, vulnerability identifier 136 can periodically query the external attack detection service for information related to potential or past attacks. In another alternative, vulnerability identifier 136 utilizes generative AI model 124 to determine if the external attack detection service has detected or published information regarding the potential attack.

In step 604, the first data is obtained responsive to detection of the attack. For example, vulnerability identifier 136 of FIG. 2 obtains data 202 responsive to detection of the attack. In this context, vulnerability identifier 136 automatically reactively identifies vulnerabilities that could place application 114 at risk of the detected attack. By automatically identifying these vulnerabilities, vulnerability identifier 136 enables system prompt generator 138 to generate or update a system prompt that includes rules for mitigating vulnerabilities to the attack without having to wait for manual rule generation, thereby increasing security with respect to application 114.

### V. Embodiments for Identifying Vulnerabilities and Generating System Prompts

As described herein, system prompt manager 122 operates to manage system prompts of applications that interact with generative AI models. In embodiments, system prompt manager 122 generates or updates system prompts to mitigate security vulnerabilities. By identifying vulnerabilities and generating system prompts that specify instructions to mitigate the identified vulnerabilities, system prompt manager 122 improves security with respect to applications that interact with generative AI models. Several further operational embodiments are described as follows with respect to vulnerability identification and system prompt generation.

System prompt manager 122 operates in various ways to identify security vulnerabilities. In some embodiments, system prompt manager 122 is able to determine whether an application provides a system prompt to a generative AI model at all. Such implementations of system prompt manager 122 operate in various ways. For example, FIG. 7 shows a flowchart 700 of a process for identifying a security vulnerability with respect to an application, in accordance with an example embodiment. In an embodiment, vulnerability identifier 136 of FIG. 2 operates according to flowchart 700. In an embodiment, flowchart 700 is a further embodiment of step 304 of flowchart 300 of FIG. 3. Note not all steps of flowchart 700 need be performed in all embodiments. Further structural and operational embodiments will be apparent to persons skilled in the relevant art(s) based on the following description of FIG. 7 with respect to FIG. 2.

Flowchart 700 comprises step 702. In step 702, the application is determined, based on the first data, to be configured to facilitate interaction between a user account and the generative AI model without providing a system prompt to the generative AI model. For example, vulnerability identifier 136 analyzes data 202 and determines application 114 does not provide a system prompt to generative AI model 124. Without providing a system prompt, application 114 is at risk of attacks that manipulate application 114 to utilize generative AI model 124 in attacks related to denial-of-wallet operations, jailbreak operations, or other malicious activity. Vulnerability identifier 136 flags or otherwise indicates this vulnerability as vulnerability 204, and causes system prompt generator 138 to generate a system prompt (such as system prompt 226) for mitigating the vulnerability.

In situations where vulnerability identifier 136 has determined that application 114 does not provide a system prompt to generative AI model 124, application interface 140 can further generate logic or other instructions that cause application 114 to provide system prompt 226 to generative AI model 124. For instance, in an implementation, application interface 140 deploys logic for performing functions similar to those described with respect to system prompt provider 126. In this context, application interface 140 ensures application 114 is configured to provide system prompt 226 to generative AI model 124.

In some embodiments, an application can already have a system prompt. In this context, system prompt manager 122 can rewrite over the system prompt by replacing the existing system prompt with a system prompt such as the system prompt generated in step 306 of flowchart 300 of FIG. 3. Alternatively, system prompt manager 122 can modify the existing system prompt. System prompt manager 122 can operate in various ways to modify existing system prompts. For instance, FIG. 8 shows a flowchart 800 of a process for hardening an existing system prompt, in accordance with an example embodiment. In an embodiment, system prompt generator 138 of FIG. 2 operates according to flowchart 800. In an embodiment, one or more steps of flowchart 800 are further implementations of step 306 of flowchart 300 of FIG. 3. Note not all steps of flowchart 800 need be performed in all embodiments. Further structural and operational embodiments will be apparent to persons skilled in the relevant art(s) based on the following description of FIG. 8 with respect to FIG. 2.

Flowchart 800 begins with step 802. In step 802, the first rule is determined based on the first security vulnerability. For example, in accordance with an embodiment, system prompt generator 138 determines rule 230 based on security vulnerability 204. In an embodiment, system prompt generator 138 determines rule 230 based on existing rules 132 and their relevance to security vulnerability 204. For instance, suppose system prompt generator 138 accesses rules 132 and searches for which ones of rules 132 relate to the same or similar domains as application 114 and/or which ones are directed to mitigating security vulnerability 204. In this context, system prompt generator 138 identifies at least one relevant rule 206 for mitigating vulnerability 204. For instance, suppose the security risk relates to a user accessing sensitive information (such as secrets, credentials, classified data, and/or the like). In this example, system prompt generator 138 identifies one or more rules of rules 132 that implement security measures for preventing access to sensitive information or generation of responses related to the sensitive information. In another example, suppose a user can attempt to instruct the generative AI model to ignore or reset its previous instructions. In this example, system prompt generator 138 can generate or determine a rule that instructs generative AI model 124 to ignore requests to disobey or ignore rules included in the system prompt.

In step 804, the first rule is inserted into a previous system prompt, resulting in the system prompt. For example, system prompt generator 138 inserts rule 206 into a previous system prompt as rule 230, resulting in system prompt 226. In this context, system prompt generator 138 accesses the existing prompt from data 202 and inserts a portion instructing the generative AI model 124 to follow rule 230 when generating responses to user prompts. For instance, continuing the example described with respect to step 802 where a security risk relates to a user accessing sensitive information, system prompt generator 138 inserts instructions for generative AI model 124 to prevent access to sensitive information or generation of responses related to the sensitive information in accordance with the identified rules of rules 132.

System prompt manager 122 can operate to mitigate various security vulnerabilities. For instance, in an embodiment system prompt manager 122 operates to mitigate ambiguities in existing system prompts or other operations of the application. System prompt manager 122 can operate in various ways to mitigate ambiguities. For example, FIG. 9 shows a flowchart 900 of a process for determining a rule to mitigate an ambiguity, in accordance with an example embodiment. In an embodiment, system prompt manager 122 of FIG. 2 operates according to flowchart 900. Note not all steps of flowchart 900 need be performed in all embodiments. Further structural and operational embodiments will be apparent to persons skilled in the relevant art(s) based on the following description of FIG. 9 with respect to FIG. 2.

Flowchart 900 begins with step 902, which is a further embodiment of step 304 of flowchart 300 of FIG. 3 in an embodiment. In step 902, an ambiguity in a question the application presents to a user interface is identified. For example, vulnerability identifier 136 of FIG. 2 can identify an ambiguity in a question application 114 presents to UI 112. In some implementations, system prompts cause generative AI models to initiate communication sessions with a user by posing a question. These questions can be broad or ambiguous, such as “What can I do for you?” An ambiguous or vague question can present an opening for a user to manipulate application 114 and/or generative AI model 124 for performing malicious activities. Vulnerability identifier 136 identifies this opening as vulnerability 204.

Flowchart 900 continues with steps 904 and 906. In an embodiment, step 904 and/or step 906 are further embodiments of step 306 of flowchart 300 of FIG. 3. In step 904, a subset of functions the generative AI model can perform is determined. For example, system prompt generator 138 determines a subset of functions generative AI model 124 can perform on behalf of application 114. In an implementation, system prompt generator 138 determines the subset of functions based at least on a domain or intended use of application 114. For instance, suppose application 114 is a scheduling assistant application that performs calendar management functions utilizing generative AI model 124. In this aspect, system prompt generator 138 determines a set of operations generative AI model 124 can perform within the domain of scheduling assistants or calendar management. In a non-limiting example, suppose system prompt generator 138 determines application 114 can utilize generative AI model 124 to set a reminder, check the weather, review appointments, or schedule a new appointment.

In step 906, the first rule is determined based on the subset of functions, the first rule causing the generative AI model to present the subset of functions as selectable options. For example, system prompt generator 138 of FIG. 2 determines rule 230 based on the subset of functions determined in step 904. In this context, system prompt generator 138 generates system prompt 226 in a manner that causes generative AI model 124 to present the subset of functions as selectable options. For instance, with continued reference to the non-limiting scheduling assistant example described with respect to step 904, system prompt generator 138 determines rule 230 to cause generative AI model 124 to present a first selectable option for setting a reminder, a second selectable option for checking the weather, a third selectable option for reviewing appointments, and a fourth selectable option for scheduling a new appointment. In this example, rule 230 prevents generative AI model 124 from responding to an option other than the presented selectable options. By restricting functions generative AI model 124 is allowed to perform with application 114, system prompt 226 generated by system prompt generator 138 reduces the ability for a malicious user to manipulate application 114 or generative AI model 124 in an attempted attack. Furthermore, restricting responses can reduce complexity of the UI by guiding the user or user-facing service in selecting from among a limited number operations.

In some implementations, system prompt manager 122 utilizes a template to generate a system prompt. A template can specify one or more rules, a syntax to be utilized in generating responses to queries, a fillable form for part or all of a system prompt, options for generating a system prompt, and/or other standardized or selectable pieces of a system prompt. System prompt manager 122 can operate in various ways to use templates for generating system prompts. For instance, FIG. 10 shows a flowchart 1000 of a process for generating a system prompt based on a template, in accordance with an example embodiment. In an embodiment, system prompt manager 122 of FIG. 2 operates according to flowchart 1000. In an embodiment, flowchart 1000 is a further example of step 306 of flowchart 300 of FIG. 3. Note not all steps of flowchart 1000 need be performed in all embodiments. Further structural and operational embodiments will be apparent to persons skilled in the relevant art(s) based on the following description of FIG. 10 with respect to FIG. 2.

Flowchart 1000 begins with step 1002. In step 1002, an application type of the application is determined. For example, system prompt generator 138 of FIG. 2 determines an application type of application 114. Depending on the implementation, the application type can be based on the domain of the application or the field in which the application is intended to facilitate operations in (for example, a healthcare domain, a business domain, a software engineering domain, and/or the like), the type of operations application is intended to facilitate (such as scheduling operations, organizing operations, database operations, translation operations, etc.), and/or the like. System prompt generator 138 can determine the application type from data 202.

In step 1004, a prompt template is selected from among a plurality of prompt templates based on the application type. For example, system prompt generator 138 of FIG. 2 selects a prompt template 208 from among templates 134 based on the application type. In an embodiment, templates 134 are indexed by identifiers corresponding to different application types. In this context, system prompt generator 138 searches templates 134 using the identifier for the application type identified in step 1002 to obtain one or more templates associated with the identifier. Alternatively, templates 134 are associated with respective keywords and system prompt generator 138 matches keywords that correspond to the application type in order to select template 208. If multiple templates are identified, system prompt generator 138 can combine the templates into a single prompt or select a best fit from amongst the multiple templates (also referred to as “candidate templates”). A best fit template can be determined based on how it can address security vulnerabilities identified by vulnerability identifier 136, based on how it can be utilized in the domain of application 114, and/or based on other information available to system prompt generator 138.

In step 1006, the prompt template is utilized to generate the system prompt. For example, system prompt generator 138 of FIG. 2 utilizes prompt template 208 to generate system prompt 226. System prompt generator 138 can use prompt template 208 by replacing placeholders of prompt template 208 with values or language corresponding to application 114's use case. As a non-limiting example, suppose application 114 is an application for scheduling flights. In this example, system prompt generator 138 selects template 208, which is a template for flight scheduling assistants. Template 208 in this example comprises one or more template rules such as: “Prevent acceptance of payment information; instead, redirect the user to [payment service]”, “Utilize [airline 1] as the primary airline for flights”, and “Utilize [list of one or more partner airlines] as secondary airlines for flights”. In these example template rules, “payment service]”, “[airline 1]”, and “[list of one or more partner airlines]” represent variable placeholders that can be substituted with application-specific values. For instance, if application 114 is a flight scheduling application for an Airline A that is partners with Airline B and Airline C and uses a Payment Service P for handling payment, system prompt generator 138 can generate system prompt 226 comprising rules “Prevent acceptance of payment information; instead redirect the user to Payment Service P” and “Utilize Airline A as the primary airline for flights and Airlines B and C as secondary airlines”. In an alternative example, suppose application 114 is a flight scheduling application for a travel agency, Agency T, that uses a Payment Service Q for handling payment and does not restrict which airlines can be used for scheduling flights. In this alternative, system prompt generator 138 can generate system prompt 226 comprising a rule “Prevent acceptance of payment information; instead redirect the user to Payment Service Q” and remove the rules regarding which airline to use as primary or secondary in scheduling flights. By leveraging templates in this manner, system prompt generator 138 can efficiently determine rules that are applicable to application 114's functionality and generate completed versions of the rules for mitigating potential vulnerabilities in application 114 utilizing generative AI model 124.

While FIG. 10 is described with respect to selecting a prompt template based on an application type, embodiments described herein are not so limited. For instance, in an embodiment, system prompt generator 138 selects a prompt template based at least on a type of security vulnerability identified with respect to the application, a tenant associated with the application, a role assigned to the user account the application is establishing a session with generative AI model 124 on behalf of, a type of generative AI model 124, and/or the like. As an example, suppose the security vulnerability identified by vulnerability identifier 136 corresponds to known vulnerabilities or attacks. In this context, a developer or automated system can generate a template comprising one or more instructions for mitigating exposure of the vulnerability or to the attack. Therefore, if vulnerability identifier 136 identified the vulnerability, system prompt generator 138 can select the template comprising instructions for mitigating the attack.

### VI. Iterative System Prompt Hardening Embodiments

Embodiments of system prompt manager 122 have been described with respect to hardening system prompts either by updating existing system prompts or generating new system prompts. In some implementations, a security vulnerability can persist in a system prompt generated by system prompt manager 122, for example, due to interactions between the generated system prompt and the application or generative AI model, due to an overlooked vulnerability, and/or the like. In other implementations, new security vulnerabilities can arise, for example, due to new methods of attack, changes in application configurations, changes in generative AI model configurations, and/or the like. Some implementations of system prompt manager 122 can further improve security with respect to application 114 and generative AI model 124 by continuing to monitor and analyze activity between application 114 and generative AI model 124 after deployment of the system prompt. In this context, system prompt manager 122 can identify and mitigate potential biases or other vulnerabilities of generative AI model 124. By identifying and mitigating these biases and vulnerabilities, system prompt manager 122 generates a new prompt that is consistent with expected and/or preferred operation of the application.

System prompt manager 122 can identify new or additional security vulnerabilities in various ways. For instance, system prompt manager 122 in an implementation can identify and mitigate another security vulnerability based on data associated with a communication session where the first security prompt was provided to generative AI model 124. For example, FIG. 11 shows a flowchart 1100 of a process for further hardening a system prompt, in accordance with an example embodiment. In an embodiment, system prompt manager 122 of FIG. 2 operates according to flowchart 1100. Note not all steps of flowchart 1100 need be performed in all embodiments. Further structural and operational embodiments will be apparent to persons skilled in the relevant art(s) based on the following description of FIG. 11 with respect to FIG. 2.

Flowchart 1100 begins with step 1102. In step 1102, second data associated with the application is received, the second data specifying a communication session wherein the application provided the user prompt and the system prompt to the generative AI model. For example, vulnerability identifier 136 of FIG. 2 receives data 232 associated with application 114. Data 232 specifies a communication session wherein application 114 provided user prompt 218 and system prompt 226 to generative AI model 124. In an embodiment, data collector 116 generates at least a portion of data 232 based at least on chat history event 224. Vulnerability identifier 136 receives data 232 in a similar manner as described with respect to data 202 in step 302 of flowchart 300 of FIG. 3.

In step 1104, a second security vulnerability of the application is identified based on the second data. For example, vulnerability identifier 136 of FIG. 2 identifies a security vulnerability 234 based at least on data 232. In embodiments, vulnerability identifier 136 identifies security vulnerability 234 in a similar manner as security vulnerability 204, such as the operations described with respect to step 304 of flowchart 300 of FIG. 3, as well as elsewhere herein. In some embodiments, security vulnerability 234 represents a vulnerability introduced based on an update to or change in either application 114 or generative AI model 124 since system prompt 226 had been deployed to application 114.

In step 1106, an updated system prompt is generated, the updated system prompt comprising instructions specifying a second rule for mitigating the second security vulnerability. For example, system prompt generator 138 of FIG. 2 generates an updated system prompt 236 comprising instructions specifying a rule for mitigating security vulnerability 234. Depending on the implementation, system prompt generator 138 generates system prompt 236 by inserting the rule into system prompt 226 or by rewriting system prompt 226 to include at lest the new rule. In some embodiments, the new rule is a revised or updated version of rule 230, in this context system prompt generator 138 rewrites or replaces rule 230. System prompt generator 138 can generate system prompt 236 in similar manners as system prompt 226, such as the operations described with respect to step 306 of flowchart 300 of FIG. 3, as well as elsewhere herein.

In step 1108, the application is caused to provide the updated system prompt to the generative AI model instead of the system prompt. For example, application interface 140 of FIG. 2 causes application 114 to provide system prompt 236 to generative AI model 124 instead of system prompt 226. As shown in FIG. 2, application interface 140 deploys system prompt 236 to application 114 via prompt deployment signal 238. In an embodiment, prompt deployment signal 238 overwrites or otherwise replaces system prompt 226 with system prompt 236. In this context, system prompt provider 126 provides system prompt 236 to generative AI model 124 via a system prompt signal 240, causing generative AI model 124 to respond to user prompts in accordance with at least the second rule included in system prompt 236 for mitigating security vulnerability 234. By routinely or continuously updating system prompts in this manner, embodiments of system prompt manager 122 are able to adapt to changes in configurations or operations of application 114 and/or generative AI model 124. Furthermore, if new attacks or vulnerabilities in existing applications or generative AI models are identified, system prompt manager 122 is able to update the system prompt to mitigate risks of susceptibility to such attacks.

### VII. Application-Side and Client-Side System Prompt Hardening Embodiments

Embodiments of system prompt manager 122 have been described as a separate service from the application it manages/generates system prompts for. However, in some implementations, system prompt manager 122 can be implemented as a service executed on the same device as the application it manages prompts for. For instance, in an embodiment, system prompt manager 122 can be implemented on application server 104 of FIG. 1. In this context, system prompt manager 122 is referred to as an “application-side” system prompt manager. This enables system prompt manager 122 to manage the system prompt of application 114 directly. By implementing system prompt manager 122 on the same server as application 114, server-to-server network traffic is reduced. Furthermore, system prompt manager 122 can leverage hardware of application server 104 for accelerating operations. Furthermore, in this context, system prompt manager 122 can be specialized to application 114. For instance, system prompt manager 122 in this context can be configured to automatically utilize a template system prompt tailored for application 114, thereby reducing compute resources in generating a system prompt.

In some implementations, system prompt manager 122 and/or application 114 are implemented on a client computing device, such as computing device 102 of FIG. 1. In this context, system prompt manager 122 can operate directly on a client computing device (for example, without relying on network servers). These implementations reduce network traffic in on-premise and cloud-network applications. Furthermore, system prompt manager 122 can leverage data related to the client computing device or operating system that would otherwise be obscured from a network-implemented service (such as due to access or security policies). This can allow system prompt manager 122 to detect vulnerabilities of the client computing device and generate a system prompt to mitigate these vulnerabilities.

In some implementations, system prompt manager 122 is implemented on a client computing device while application 114 is implemented on a separate application server (for instance, an on-premise server or a cloud network server). In this implementation, system prompt manager 122 can detect security vulnerabilities in application 114 that could expose client data to attacks and generate a system prompt for mitigating the risk of exposing the client's sensitive data.

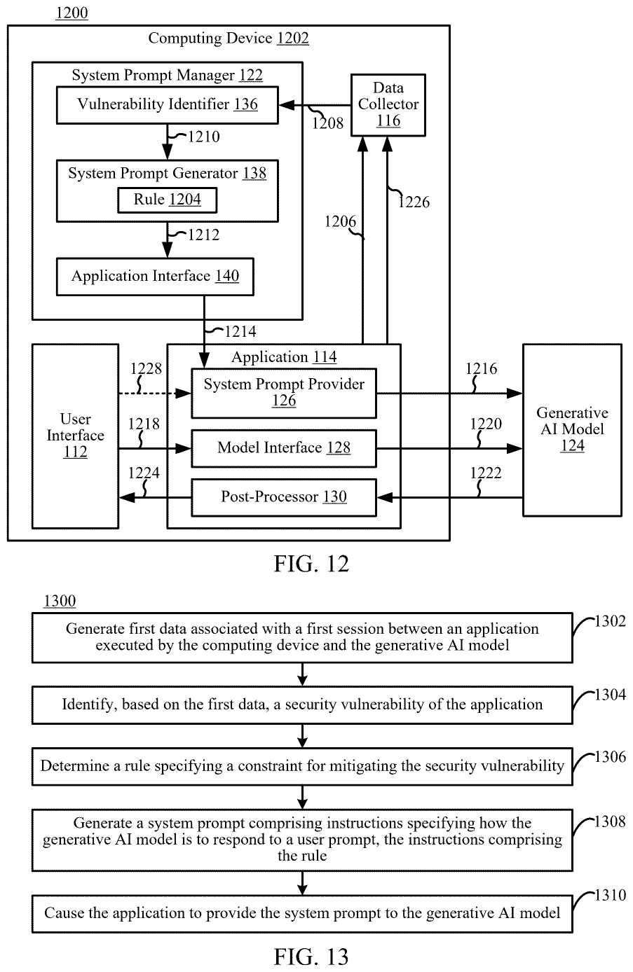

Thus, various implementations of client-side or application-side system prompt managers have been described. In order to better understand an implementation of a client-side and application-side system prompt managers, FIG. 12 is described. FIG. 12 shows a system 1200 for client-side system prompt hardening, in accordance with an example embodiment. As shown in FIG. 12, system 1200 comprises generative AI model 124, as described with respect to FIG. 1, as well as a computing device 1202. In an embodiment, computing device 1202 is an implementation of computing device 102 or application server 104, as described with respect to FIG. 1. As also shown in FIG. 12, computing device 1202 comprises user interface 112, application 114 (comprising system prompt provider 126, model interface 128, and post-processor 130), data collector 116, and system prompt manager 122 (comprising vulnerability identifier 136, system prompt generator 138, and application interface 140), as described with respect to FIG. 1. In the implementation depicted in FIG. 12, computing device 1202 is also referred to as a “client-side computing device” or “client-facing computing device”. Alternatively, computing device 1202 can be implemented as a server remotely located from a user or otherwise separate from the user's computing device (such as a cloud-based server or an on-premise server). In this alternative context, user interface 112 is implemented on the user's computing device (such as computing device 102) and communicatively coupled to application 114 (for example, over a network).

To better understand the operation of system prompt manager 122 with respect to computing device 1202, FIG. 12 is described with respect to FIG. 13. FIG. 13 shows a flowchart 1300 of a process for application-side system prompt hardening, in accordance with an example embodiment. In an embodiment, system prompt manager 122 of FIG. 12 operates according to flowchart 1300. Note not all steps of flowchart 1300 need be performed in all embodiments. Further structural and operational embodiments will be apparent to persons skilled in the relevant art(s) based on the following descriptions of FIGS. 12 and 13.

Flowchart 1300 begins with step 1302. In step 1302, first data associated with a first session between an application executed by the computing device and the generative AI model is generated. For example, vulnerability identifier 136 of FIG. 12 receives data 1208 associated with a first communication session between application 114 and generative AI model 124. In an embodiment, data 1208 is generated by data collector 116 collecting data 1206 from application 114 regarding a communication session established between UI 112 and generative AI model 124. In an embodiment, data collector 116 generates data 1208 in a similar manner as data 202 described with respect to FIG. 2. Vulnerability identifier 136 can receive data 1208 periodically, responsive to changes in data collected by data collector 116, or in other manners as described elsewhere herein.

In step 1304, a security vulnerability of the application is identified based on the first data. For example, vulnerability identifier 136 of FIG. 12 identifies a security vulnerability 1210 based at least on data 1208. Vulnerability identifier 136 identifies security vulnerability 1210 in a similar manner as described with respect to vulnerability identifier 136 of FIG. 2 determining security vulnerability 204.

In step 1306, a rule specifying a constraint for mitigating the security vulnerability is determined. For example, system prompt generator 138 of FIG. 12 determines rule 1204 specifying a constraint for mitigating security vulnerability 1210. System prompt generator 138 determines rule 1204 in a similar manner as rule 230 of FIG. 2.

In step 1308, a system prompt comprising instructions specifying how the generative AI model is to respond to a user prompt is generated, the instructions comprising the rule. For example, system prompt generator 138 of FIG. 12 generates a system prompt 1212 comprising instructions specifying how generative AI model 124 is to respond to a user prompt, the instructions comprising rule 1204. System prompt generator 138 can generate system prompt 1212 in a variety of ways, such as those described with respect to generating system prompt 226.

In step 1310, the application is caused to provide the system prompt to the generative AI model. For example, application interface 140 provides system prompt 1212 to system prompt provider 126 via prompt deployment signal 1214, causing application 114 to provide system prompt 1212 to generative AI model 124. Application interface 140 can deploy prompts to application 114 in various ways, for instance, in similar manners as described with respect to FIG. 2. In some embodiments, such as wherein system prompt manager 122 is integrated as a subcomponent of application 114, system prompt generator 138 provides system prompt 1212 to system prompt provider 126 directly.

### VIII. Example Computer System Implementation

Systems, devices, components, and/or techniques described herein are implemented in hardware, or hardware combined with one or both of software and/or firmware. For example, UI 112, application 114, data collector 116, rules manager 118, template manager 120, system prompt manager 122, generative AI model 124, and/or each of the components described therein, and/or the steps of flowcharts 300, 400, 500, 600, 700, 800, 900, 1000, 1100, and/or 1300 are each implemented as computer program code/instructions configured to be executed in one or more processors and stored in a computer readable storage medium. Alternatively, data collector 116, rules manager 118, template manager 120, system prompt manager 122, and/or each of the components described therein, and/or the steps of flowcharts 300, 400, 500, 600, 700, 800, 900, 1000, 1100, and/or 1300 are each implemented in one or more SoCs (system on chip). An SoC includes an integrated circuit chip that includes one or more of a processor (such as a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 14. FIG. 14 shows a block diagram of an exemplary computing environment 1400 that includes a computing device 1402. Computing device 1402 is an example of computing device 102, application server 104, system prompt management server 106, model server 110, and/or computing device 1202, which each include one or more of the components of computing device 1402. In some embodiments, computing device 1402 is communicatively coupled with devices (not shown in FIG. 14) external to computing environment 1400 via network 1404. In accordance with an embodiment, network 1404 is an example of network 148 of FIG. 1. Network 1404 comprises one or more networks such as local area networks (LANs), wide area networks (WANs), enterprise networks, the Internet, etc. In examples, network 1404 includes one or more wired and/or wireless portions. In some examples, network 1404 additionally or alternatively includes a cellular network for cellular communications. Computing device 1402 is described in detail as follows.

Computing device 1402 can be any of a variety of types of computing devices. Examples of computing device 1402 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1402 is a stationary computing device such as a desktop computer, a personal computer (PC), a stationary server device, a minicomputer, a mainframe, a supercomputer, etc.

As shown in FIG. 14, computing device 1402 includes a variety of hardware and software components, including a processor 1410, a storage 1420, a graphics processing unit (GPU) 1442, a neural processing unit (NPU) 1444, one or more input devices 1430, one or more output devices 1450, one or more wireless modems 1460, one or more wired interfaces 1480, a power supply 1482, a location information (LI) receiver 1484, and an accelerometer 1486. Storage 1420 includes memory 1456, which includes non-removable memory 1422 and removable memory 1424, and a storage device 1488. Storage 1420 also stores an operating system 1412, application programs 1414, and application data 1416. Wireless modem(s) 1460 include a Wi-Fi modem 1462, a Bluetooth modem 1464, and a cellular modem 1466. Output device(s) 1450 includes a speaker 1452 and a display 1454. Input device(s) 1430 includes a touch screen 1432, a microphone 1434, a camera 1436, a physical keyboard 1438, and a trackball 1440. Not all components of computing device 1402 shown in FIG. 14 are present in all embodiments, additional components not shown may be present, and in a particular embodiment any combination of the components are present. In examples, components of computing device 1402 are mounted to a circuit card (e.g., a motherboard) of computing device 1402, integrated in a housing of computing device 1402, or otherwise included in computing device 1402. The components of computing device 1402 are described as follows.

In embodiments, a single processor 1410 (e.g., central processing unit (CPU), microcontroller, a microprocessor, signal processor, ASIC (application specific integrated circuit), and/or other physical hardware processor circuit) or multiple processors 1410 are present in computing device 1402 for performing such tasks as program execution, signal coding, data processing, input/output processing, power control, and/or other functions. In examples, processor 1410 is a single-core or multi-core processor, and each processor core is single-threaded or multithreaded (to provide multiple threads of execution concurrently). Processor 1410 is configured to execute program code stored in a computer readable medium, such as program code of operating system 1412 and application programs 1414 stored in storage 1420. The program code is structured to cause processor 1410 to perform operations, including the processes/methods disclosed herein. Operating system 1412 controls the allocation and usage of the components of computing device 1402 and provides support for one or more application programs 1414 (also referred to as “applications” or “apps”). In examples, application programs 1414 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1410 includes one or more general processors (e.g., CPUs) configured with or coupled to one or more hardware accelerators, such as one or more NPUs 1444 and/or one or more GPUs 1442.

Any component in computing device 1402 can communicate with any other component according to function, although not all connections are shown for ease of illustration. For instance, as shown in FIG. 14, bus 1006 is a multiple signal line communication medium (e.g., conductive traces in silicon, metal traces along a motherboard, wires, etc.) present to communicatively couple processor 1410 to various other components of computing device 1402, although in other embodiments, an alternative bus, further buses, and/or one or more individual signal lines is/are present to communicatively couple components. Bus 1006 represents one or more of any of several types of bus structures, including a memory bus or memory controller, a peripheral bus, an accelerated graphics port, and a processor or local bus using any of a variety of bus architectures.

Storage 1420 is physical storage that includes one or both of memory 1456 and storage device 1488, which store operating system 1412, application programs 1414, and application data 1416 according to any distribution. In an embodiment, storage 1420 is an example implementation of storage 108 of FIG. 1. Non-removable memory 1422 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1422 includes main memory and is separate from or fabricated in a same integrated circuit as processor 1410. As shown in FIG. 14, non-removable memory 1422 stores firmware 1418 that is present to provide low-level control of hardware. Examples of firmware 1418 include BIOS (Basic Input/Output System, such as on personal computers) and boot firmware (e.g., on smart phones). In examples, removable memory 1424 is inserted into a receptacle of or is otherwise coupled to computing device 1402 and can be removed by a user from computing device 1402. Removable memory 1424 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1488 are present that are internal and/or external to a housing of computing device 1402 and are or are not removable. Examples of storage device 1488 include a hard disk drive, an SSD, a thumb drive (e.g., a USB (Universal Serial Bus) flash drive), or other physical storage device.

One or more programs are stored in storage 1420. Such programs include operating system 1412, one or more application programs 1414, and other program modules and program data. Examples of such application programs include computer program logic (e.g., computer program code/instructions) for implementing UI 112, application 114, data collector 116, rules manager 118, template manager 120, system prompt manager 122, and/or generative AI model 124, and/or each of the components described therein, and/or the steps of flowcharts 300, 400, 500, 600, 700, 800, 900, 1000, 1100, and/or 1200, and/or any individual steps thereof.

Storage 1420 also stores data used and/or generated by operating system 1412 and application programs 1414 as application data 1416. Examples of application data 1416 include web pages, text, images, tables, sound files, video data, and other data. In examples, application data 1416 is sent to and/or received from one or more network servers or other devices via one or more wired or wireless networks. Storage 1420 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1402 through one or more input devices 1430 and receives information from computing device 1402 through one or more output devices 1450. Input device(s) 1430 includes one or more of touch screen 1432, microphone 1434, camera 1436, physical keyboard 1438 and/or trackball 1440 and output device(s) 1450 includes one or more of speaker 1452 and display 1454. Each of input device(s) 1430 and output device(s) 1450 are integral to computing device 1402 (e.g., built into a housing of computing device 1402) or are external to computing device 1402 (e.g., communicatively coupled wired or wirelessly to computing device 1402 via wired interface(s) 1480 and/or wireless modem(s) 1460). Further input devices 1430 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1454 displays information, as well as operating as touch screen 1432 by receiving user commands and/or other information (e.g., by touch, finger gestures, virtual keyboard, etc.) as a user interface. Any number of each type of input device(s) 1430 and output device(s) 1450 are present, including multiple microphones 1434, multiple cameras 1436, multiple speakers 1452, and/or multiple displays 1454.

In embodiments where GPU 1442 is present, GPU 1442 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1442 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1444 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1428. In an example, NPU 1444 is configured for a data-driven parallel computing and is highly efficient at processing massive multimedia data such as videos and images and processing data for neural networks. NPU 1444 is configured for efficient handling of AI-related tasks, such as speech recognition, background blurring in video calls, photo or video editing processes like object detection, etc.

In embodiments disclosed herein that implement ML models, NPU 1444 can be utilized to execute such ML models, of which MLM 1428 is an example. For instance, where applicable, MLM 1428 is a generative AI model (e.g., generative AI model 124 of FIG. 1) that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1444 is used to train MLM 1428. To train MLM 1428, training data is that includes input features (attributes) and their corresponding output labels/target values (e.g., for supervised learning) is collected. A training algorithm is a computational procedure that is used so that MLM 1428 learns from the training data. Parameters/weights are internal settings of MLM 1428 that are adjusted during training by the training algorithm to reduce a difference between predictions by MLM 1428 and actual outcomes (e.g., output labels). In some examples, MLM 1428 is set with initial values for the parameters/weights. A loss function measures a dissimilarity between predictions by MLM 1428 and the target values, and the parameters/weights of MLM 1428 are adjusted to minimize the loss function. The parameters/weights are iteratively adjusted by an optimization technique, such as gradient descent. In this manner, MLM 1428 is generated through training by NPU 1444 to be used to generate inferences based on received input feature sets for particular applications. MLM 1428 is generated as a computer program or other type of algorithm configured to generate an output (e.g., a classification, a prediction/inference) based on received input features, and is stored in the form of a file or other data structure.

In examples, such training of MLM 1428 by NPU 1444 is supervised or unsupervised. According to supervised learning, input objects (e.g., a vector of predictor variables) and a desired output value (e.g., a human-labeled supervisory signal) train MLM 1428. The training data is processed, building a function that maps new data on expected output values. Example algorithms usable by NPU 1444 to perform supervised training of MLM 1428 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1428 is an LLM, MLM 1428 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1428 is trained to learn patterns from unlabeled data. For instance, in embodiments where MLM 1428 implements unsupervised learning techniques, MLM 1428 identifies one or more classifications or clusters to which an input belongs. During a training phase of MLM 1428 according to unsupervised learning, MLM 1428 tries to mimic the provided training data and uses the error in its mimicked output to correct itself (i.e., correct weights and biases). In further examples, NPU 1444 perform unsupervised training of MLM 1428 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1444 need not necessarily be present in all ML model embodiments. In embodiments where ML models are present, any one or more of processor 1410, GPU 1442, and/or NPU 1444 can be present to train and/or execute MLM 1428.

One or more wireless modems 1460 can be coupled to antenna(s) (not shown) of computing device 1402 and can support two-way communications between processor 1410 and devices external to computing device 1402 through network 1404, as would be understood to persons skilled in the relevant art(s). Wireless modem 1460 is shown generically and can include a cellular modem 1466 for communicating with one or more cellular networks, such as a GSM network for data and voice communications within a single cellular network, between cellular networks, or between the mobile device and a public switched telephone network (PSTN). In examples, wireless modem 1460 also or alternatively includes other radio-based modem types, such as a Bluetooth modem 1464 (also referred to as a “Bluetooth device”) and/or Wi-Fi modem 1462 (also referred to as an “wireless adaptor”). Wi-Fi modem 1462 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1464 is configured to communicate with another Bluetooth-capable device according to the Bluetooth short-range wireless technology standard(s) such as IEEE 802.15.1 and/or managed by the Bluetooth Special Interest Group (SIG).

Computing device 1402 can further include power supply 1482, LI receiver 1484, accelerometer 1486, and/or one or more wired interfaces 1480. Example wired interfaces 1480 include a USB port, IEEE 1394 (FireWire) port, a RS-142 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1480 of computing device 1402 provide for wired connections between computing device 1402 and network 1404, or between computing device 1402 and one or more devices/peripherals when such devices/peripherals are external to computing device 1402 (e.g., a pointing device, display 1454, speaker 1452, camera 1436, physical keyboard 1438, etc.). Power supply 1482 is configured to supply power to each of the components of computing device 1402 and receives power from a battery internal to computing device 1402, and/or from a power cord plugged into a power port of computing device 1402 (e.g., a USB port, an A/C power port). LI receiver 1484 is useable for location determination of computing device 1402 and in examples includes a satellite navigation receiver such as a Global Positioning System (GPS) receiver and/or includes other type of location determiner configured to determine location of computing device 1402 based on received information (e.g., using cell tower triangulation, etc.). Accelerometer 1486, when present, is configured to determine an orientation of computing device 1402.

Note that the illustrated components of computing device 1402 are not required or all-inclusive, and fewer or greater numbers of components can be present as would be recognized by one skilled in the art. In examples, computing device 1402 includes one or more of a gyroscope, barometer, proximity sensor, ambient light sensor, digital compass, etc. In an example, processor 1410 and memory 1456 are co-located in a same semiconductor device package, such as being included together in an integrated circuit chip, FPGA, or system-on-chip (SOC), optionally along with further components of computing device 1402.

In embodiments, computing device 1402 is configured to implement any of the above-described features of flowcharts herein. Computer program logic for performing any of the operations, steps, and/or functions described herein is stored in storage 1420 and executed by processor 1410.

In some embodiments, server infrastructure 1470 is present in computing environment 1400 and is communicatively coupled with computing device 1402 via network 1404. Server infrastructure 1470, when present, is a network-accessible server set (e.g., a cloud-based environment or platform). As shown in FIG. 14, server infrastructure 1470 includes clusters 1472. Each of clusters 1472 comprises a group of one or more compute nodes and/or a group of one or more storage nodes. For example, as shown in FIG. 14, cluster 1472 includes nodes 1474. Each of nodes 1474 are accessible via network 1404 (e.g., in a “cloud-based” embodiment) to build, deploy, and manage applications and services. In examples, any of nodes 1474 is a storage node that comprises a plurality of physical storage disks, SSDs, and/or other physical storage devices that are accessible via network 1404 and are configured to store data associated with the applications and services managed by nodes 1474.

Each of nodes 1474, as a compute node, comprises one or more server computers, server systems, and/or computing devices. For instance, a node 1474 in accordance with an embodiment includes one or more of the components of computing device 1402 disclosed herein. Each of nodes 1474 is configured to execute one or more software applications (or “applications”) and/or services and/or manage hardware resources (e.g., processors, memory, etc.), which are utilized by users (e.g., customers) of the network-accessible server set. In examples, as shown in FIG. 14, nodes 1474 includes a node 1446 that includes storage 1448 and/or one or more of a processor 1458 (e.g., similar to processor 1410, GPU 1442, and/or NPU 1444 of computing device 1402). Storage 1448 stores application programs 1476 and application data 1478. Processor(s) 1458 operate application programs 1476 which access and/or generate related application data 1478. In an implementation, nodes such as node 1446 of nodes 1474 operate or comprise one or more virtual machines, with each virtual machine emulating a system architecture (e.g., an operating system), in an isolated manner, upon which applications such as application programs 1476 are executed.

In embodiments, one or more of clusters 1472 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1472 are included in a datacenter in a distributed collection of datacenters. In embodiments, exemplary computing environment 1400 comprises part of a cloud-based platform.

In an embodiment, computing device 1402 accesses application programs 1476 for execution in any manner, such as by a client application and/or a browser at computing device 1402.

In an example, for purposes of network (e.g., cloud) backup and data security, computing device 1402 additionally and/or alternatively synchronizes copies of application programs 1414 and/or application data 1416 to be stored at network-based server infrastructure 1470 as application programs 1476 and/or application data 1478. In examples, operating system 1412 and/or application programs 1414 include a file hosting service client configured to synchronize applications and/or data stored in storage 1420 at network-based server infrastructure 1470.

In some embodiments, on-premises servers 1492 are present in computing environment 1400 and are communicatively coupled with computing device 1402 via network 1404. On-premises servers 1492, when present, are hosted within an organization's infrastructure and, in many cases, physically onsite of a facility of that organization. On-premises servers 1492 are controlled, administered, and maintained by IT (Information Technology) personnel of the organization or an IT partner to the organization. Application data 1498 can be shared by on-premises servers 1492 between computing devices of the organization, including computing device 1402 (when part of an organization) through a local network of the organization, and/or through further networks accessible to the organization (including the Internet). Furthermore, in examples, on-premises servers 1492 serve applications such as application programs 1496 to the computing devices of the organization, including computing device 1402. Accordingly, in examples, on-premises servers 1492 include storage 1494 (which includes one or more physical storage devices such as storage disks and/or SSDs) for storage of application programs 1496 and application data 1498 and include a processor 1490 (e.g., similar to processor 1410, GPU 1442, and/or NPU 1444 of computing device 1402) for execution of application programs 1496. In some embodiments, multiple processors 1490 are present for execution of application programs 1496 and/or for other purposes. In further examples, computing device 1402 is configured to synchronize copies of application programs 1414 and/or application data 1416 for backup storage at on-premises servers 1492 as application programs 1496 and/or application data 1498.

Embodiments described herein may be implemented in one or more of computing device 1402, network-based server infrastructure 1470, and on-premises servers 1492. For example, in some embodiments, computing device 1402 is used to implement systems, clients, or devices, or components/subcomponents thereof, disclosed elsewhere herein. In other embodiments, a combination of computing device 1402, network-based server infrastructure 1470, and/or on-premises servers 1492 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1420. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1414) are stored in storage 1420. Such computer programs can also be received via wired interface(s) 1460 and/or wireless modem(s) 1460 over network 1404. Such computer programs, when executed or loaded by an application, enable computing device 1402 to implement features of embodiments discussed herein. Accordingly, such computer programs represent controllers of the computing device 1402.

Embodiments are also directed to computer program products comprising computer code or instructions stored on any computer-readable medium or computer-readable storage medium. Such computer program products include the physical storage of storage 1420 as well as further physical storage types.

### IX. Additional Exemplary Embodiments

A method is described herein. The method comprises: receiving first data associated with an application for facilitating interactions with a generative AI model; identifying, based on the first data, a first security vulnerability of the application; generating a first system prompt comprising instructions specifying how the generative AI model is to respond to a user prompt, the instructions comprising a first rule for mitigating the first security vulnerability; causing the application to provide the first system prompt to the generative AI model.

In a further example of the foregoing method, the first data corresponds to a first communication session between the application and the generative AI model.

In a further example of the foregoing method, the first data corresponds to a first communication session between a user-facing service and the generative AI model facilitated by the application.

In a further example of the foregoing method, the first data specifies a previous system prompt provided to the generative AI model.

In a further example of the foregoing method, the first data specifies a previous user prompt provided to the generative AI model.

In a further example of the foregoing method, the first rule specifies a constraint for mitigating the first security vulnerability.

In a further example of the foregoing method, the first system prompt is generated by updating a previous system prompt to include the first rule.

In a further example of the foregoing method, said generating the first system prompt comprises: determining an application type of the application; selecting a prompt template from among a plurality of prompt templates based on the application type, the prompt template comprising the first rule; and utilizing the prompt template to generate the first system prompt.

In a further example of the foregoing method, the first security vulnerability corresponds to an ambiguity in a question the application presents a user. Said generating the first system prompt comprises: determining a subset of functions the generative AI model can perform, the subset of functions on a list of authorized functions; generating the first rule based on the subset of functions, the first rule causing the generative AI model to present the subset of functions as selectable options.

In a further example of the foregoing method, wherein the first rule causes the generative AI model to reject a prompt for selecting a function other than the subset of functions.

In a further example of the foregoing method, the method further comprises: receiving second data associated with the application, the second data specifying a communication session wherein the application provided a user prompt and the first system prompt to the generative AI model; identifying, based on the second data, a second security vulnerability of the application; generating a second system prompt comprising instructions specifying a second rule for mitigating the second security vulnerability; and causing the application to provide the second system prompt to the generative AI model instead of the first system prompt.

In a further example of the foregoing method, wherein said generating the second system prompt comprises: updating the first system prompt to include the second rule.

In a further example of the foregoing method, wherein said generating the second system prompt comprises: rewriting the first system prompt to include the second rule.

In a further example of the foregoing method, said identifying the first security vulnerability comprises: determining a level of similarity between the application and a comprised application that was subject to a cyberattack satisfies a threshold condition; and identifying the first security vulnerability based at least on the threshold condition being satisfied.

In a further example of the foregoing method, the first data specifies a previous system prompt of the application. Said generating the first system prompt comprises: determining the first rule based on the first security vulnerability; and inserting the first rule into the previous system prompt.

In a further example of the foregoing method, said identifying the first security vulnerability comprises determining, based on the first data, the application is configured to facilitate interactions between a user account and the generative AI model without providing a system prompt to the generative AI model.

In a further example of the foregoing method, wherein said receiving the first data further comprises: detecting an attack with respect to the application; and responsive to detecting the attack, obtaining the first data.

In a further example of the foregoing method, wherein said causing the application to provide the first system prompt to the generative AI model comprises: causing the application to: subsequent to establishing a communication session between a user account and the generative AI model, provide the system prompt to the generative AI model, and provide the second user prompt to the generative AI model.

In a further example of the foregoing method, wherein said causing the application to provide the first system prompt to the generative AI model comprises: causing the application to provide the first system prompt to the generative AI model to establish a communication session.

In a further example of the foregoing method, wherein said receiving the first data further comprises: determining a period of time since a previous system prompt was provided to the application satisfies a threshold condition; and obtaining the first data responsive to the threshold condition being satisfied.

In a further example of the foregoing method, the method further comprises, causing the application to receive a response from the generative AI model that satisfies the first rule and causing the application to present the response in a user interface communicatively coupled thereto.

A computing device comprising a processor and memory is described herein. The memory stores program code structured to cause the processor to perform any of the foregoing methods.

In a further example of the foregoing computing device, the program code comprises the application.

In a further example of the foregoing computing device, the program code comprises the user interface.

In a further example of the foregoing computing device, the program code comprises the generative AI model.

A system comprising a processor and memory is described herein. The memory storing program code structured to cause the processor to perform any of the foregoing methods.

In a further example of the foregoing system, the system comprises the foregoing computing device.

In a further example of the foregoing system, the system comprises the generative AI model.

In a further example of the foregoing method, the system comprises a client computing device executing the user interface.

In a further example of the foregoing method, the system comprises an application server executing the application.

A computer-readable storage medium encoded with program instructions that, when executed by a processor circuit, perform any of the foregoing methods described herein.

### X. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, applications, data collectors, rules managers, template managers, system prompt managers, generative AI models, and/or their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A system comprising:
a processor; and
a memory that stores program code structured to cause the processor to:
receive first data associated with an application for facilitating interactions with a generative artificial intelligence (AI) model, the first data specifying a first user prompt the application provided to the generative AI model,
identify, based on the first data, a first security vulnerability of the application,
generate a system prompt comprising instructions specifying how the generative AI model is to respond to a second user prompt, the instructions comprising a first rule for mitigating the first security vulnerability, and
cause the application to provide the system prompt to the generative AI model, causing the generative AI model to respond to the second user prompt in accordance with the first rule.

2. The system of claim 1, wherein to generate the system prompt, the program code is further structured to cause the processor to:
determine an application type of the application;
select a prompt template from among a plurality of prompt templates based on the application type, the prompt template comprising the first rule; and
utilize the prompt template to generate the system prompt.

3. The system of claim 1, wherein the first security vulnerability corresponds to an ambiguity in a question the application presents a user and to generate the system prompt, the program code is further structured to cause the processor to:
determine a subset of functions the generative AI model can perform, the subset of functions on a list of authorized functions; and
generate the first rule based on the subset of functions, the first rule causing the generative AI model to present the subset of functions as selectable options.

4. The system of claim 3, wherein first rule causes the generative AI model to reject a prompt for selecting a function other than the subset of functions.

5. The system of claim 1, the program code is further structured to cause the processor to:
receive second data associated with the application, the second data specifying a communication session wherein the application provided the second user prompt and the system prompt to the generative AI model;
identify, based on the second data, a second security vulnerability of the application;
generate an updated system prompt comprising instructions specifying a second rule for mitigating the second security vulnerability; and
cause the application to provide the updated system prompt to the generative AI model instead of the system prompt.

6. The system of claim 1, wherein the first data specifies a previous system prompt of the application and to generate the system prompt, the program code is further structured to cause the processor to:
determine the first rule based on the first security vulnerability; and
insert the first rule into the previous system prompt.

7. The system of claim 1, wherein to identify the first security vulnerability, the program code is further structured to:
determine, based on the first data, the application is configured to facilitate interactions between a user account and the generative AI model without providing the system prompt to the generative AI model.

8. The system of claim 1, wherein to receive the first data, the program code is further
detect an attack with respect to the application; and
responsive to detection of the attack, obtain the first data.

9. The system of claim 1, wherein to cause the application to provide the system prompt to the generative AI model, the program code is further structured to cause the processor to:
cause the application to:
subsequent to establishing a communication session between a user account and the generative AI model, provide the system prompt to the generative AI model, and
provide the second user prompt to the generative AI model.

10. The system of claim 1, wherein to cause the application to provide the system prompt to the generative AI model, the program code is further structured to cause the processor to:
cause the application to:
provide the system prompt to the generative AI model to establish a communication session.

11. A method for rewriting system prompts, the method comprising:
receiving first data associated with a first session between an application and a generative AI model, the first data specifying a first system prompt the application provided to the generative AI model;
identifying, based on the first data, a first security vulnerability of the application;
updating the first system prompt with a first rule specifying a constraint to mitigate the first security vulnerability of the application, the updated first system prompt being a second system prompt;
causing the application to provide the second system prompt to the generative AI model.

12. The method of claim 11, wherein said updating the first system prompt comprises:
determining an application type of the application;
selecting a prompt template from among a plurality of prompt templates based on the application type, the prompt template comprising the first rule; and
utilizing the prompt template to update the first system prompt into the second system prompt.

13. The method of claim 11, wherein the first security vulnerability corresponds to an ambiguity in a question the application presents a user and said updating the first system prompt comprises:
determining a subset of functions the generative AI model can perform, the subset of functions on a list of authorized functions;
generating the first rule based on the subset of functions, the first rule causing the generative AI model to present the subset of functions as selectable options.

14. The method of claim 11, further comprising:
receiving second data associated with the application, the second data specifying a communication session wherein the application provided a user prompt and the second system prompt to the generative AI model;
identifying, based on the second data, a second security vulnerability of the application;
updating the second system prompt with instructions specifying a second rule for mitigating the second security vulnerability, the updated second system prompt being a third system prompt; and
cause the application to provide the third system prompt to the generative AI model instead of the second system prompt.

15. The method of claim 11, wherein said identifying the first security vulnerability comprises:
determining a level of similarity between the application and a comprised application that was subject to a cyberattack satisfies a threshold condition; and
identify the first security vulnerability based at least on the threshold condition being satisfied.

16. The method of claim 11, wherein said receiving the first data further comprises:
detecting an attack with respect to the application; and
responsive to detecting the attack, obtaining the first data.

17. The method of claim 11, wherein said receiving the first data further comprises:
determining a period of time since the first system prompt was provided to the application satisfies a threshold condition; and
obtaining the first data responsive to the threshold condition being satisfied.

18. A computing device communicatively coupled to a server device executing a generative AI model, the computing device comprising:
a processor; and
a memory that stores program code structured to cause the processor to:
generate first data associated with a first session between an application executed by the computing device and the generative AI model,
identify, based on the first data, a first security vulnerability of the application,
determine a first rule specifying a constraint for mitigating the first security vulnerability,
generate a first system prompt comprising instructions specifying how the generative AI model is to respond to a second user prompt, the instructions comprising the first rule, and
cause the application to provide the first system prompt to the generative AI model responsive to establishing a second session with the generative AI model.

19. The computing device of claim 18, the program code is further structured to cause the processor to:
receive second data associated with the application, the second data specifying the second session wherein the application provided a user prompt and the first system prompt to the generative AI model;
identify, based on the second data, a second security vulnerability of the application;
generate a second system prompt comprising a second rule for mitigating the second security vulnerability; and
cause the application to provide the second system prompt to the generative AI model instead of the first system prompt.

20. The computing device of claim 18, the program code is further structured to cause the processor to:
provide, to the generative AI model, a user prompt during the second session;
receive, from the generative AI model, a response to the user prompt, the response satisfying the first rule; and
cause the response to be presented in a user interface communicatively coupled to the computing device.
